(19) United States
(12) Patent Application Publication
(10) Pub. No.: US 2007/0025620 A1
(43) Pub. Date: Feb. 1, 2007

(54) Method for determining contours in images

(76) Inventor: Ulrich Lauther, Munchen (DE)

Correspondence Address: HARNESS, DICKEY & PIERCE, P.L.C., P.O.BOX 8910, RESTON, VA, 20195, US

(21) Appl. No.: 11/494,507

(22) Filed: Jul. 28, 2006

(30) Foreign Application Priority Data
Jul. 29, 2005 (DE) 10 2005 035 670.2

(51) Int. Cl. G06K 9/48; G06K 9/00

(52) U.S. Cl. 382/199; 382/128

(57) ABSTRACT

A method is disclosed for determining at least one contour in at least one image represented by a pixel array, a certain pixel value which represents a color hue or gray level being assigned to each pixel of the pixel array. The method includes stipulation of at least two contour reference points, wherein each contour reference point corresponds to a pixel of the pixel array, and mapping of the pixel array onto a grid, wherein the grid nodes represent the pixels of the pixel array, and the grid lines connect the grid nodes to one another. The method further includes assignment of a certain grid-line section value to each grid-line section between two grid nodes and determination of the respective sum of all the grid-line section values for multiple grid-line paths between the contour reference points. Finally, the method includes determination of the particular grid-line path, the sum of whose associated grid-line section values assumes a minimum, wherein the grid-line path determined represents the contour to be determined.

### PRIORITY STATEMENT

The present application hereby claims priority under 35 U.S.C. §119 on German patent application number DE 10 2005 035 670.2 filed Jul. 29, 2005, the entire contents of which is hereby incorporated herein by reference.

### FIELD

The invention generally relates to a method for determining contours in images which are represented by pixel arrays. For example, it may relate to a method wherein a certain pixel value, which represents a color hue or gray level, is assigned to each pixel in the pixel array.

### BACKGROUND

Methods are used, in particular, for analyzing/evaluating medical images (e.g. X-ray images, computer tomography (CT) images, etc.) in order to facilitate the pinpointing of certain organs or parts of the body within the images. The identification of such organs/parts of the body (e.g. of tumors) serves, in particular, diagnostic purposes and can moreover be used for planning a treatment (e.g. a radiation therapy).

### SUMMARY

A method for determining contours in images is disclosed in at least one embodiment, which permits the fast and efficient determination of contours and enables a user to influence the method interactively.

At least one embodiment of the invention provides a method for determining contours in images.

The inventive method of at least one embodiment serves in determining contours in an image which is represented by a pixel array, whereby a certain pixel value which represents a color hue or a gray level is assigned to each pixel of the pixel array, and comprises:

stipulation of at least two contour reference points, each contour reference point corresponding to a pixel of the pixel array,

mapping of the pixel array onto a grid, the grid nodes representing the pixels of the pixel array, and the grid lines connecting the grid nodes to one another,

assignment of a certain grid-line section value to each

grid-line section between two grid nodes,

determination of the respective sum of all the grid-line section values for multiple grid-line paths between the contour reference points, and

determination of the grid-line path, the sum of whose associated grid-line section values assumes a minimum, the grid-line path determined representing the contour to be determined.

In an example embodiment, the grid-line section values are derived from the pixel values of those pixels which are connected to one another by the corresponding grid-line path, and/or from the pixel values of pixels adjacent thereto and/or from the geometric lengths of the grid-line sections.

For example, the negative absolute values of the gradients of the pixel values perpendicular to the corresponding grid-line path can be input into the calculation of the grid-line section values.

Additionally/alternatively, the absolute values of the gradients of the pixel values along the corresponding grid-line path can be input into the calculation of the grid-line section values.

In an example embodiment, multiple calculation methods are input into the calculation of the grid-line section values, the different calculation methods being weighted in relation to one another according to a control parameter.

In principle, any grid can be used. For example, however, each grid node may be connected to the eight nearest grid nodes via grid-line sections running horizontally, vertically and diagonally.

The control parameter can advantageously be specified/modified by a user, so that it is possible for the user to influence the inventive method interactively. Influence can also be exerted interactively in that the contour reference points can be specified/modified by a user.

In an example embodiment, the grid-line path which represents the contour to be determined is determined using the Dijkstra algorithm However, other algorithms can also be used for this purpose.

### BRIEF DESCRIPTION OF THE DRAWINGS

The invention is explained in detail in an example embodiment below with reference to the Figures, in which:

FIG. 1 shows an example embodiment of a detail of a pixel array which is used in the inventive method.

FIG. 2 shows a detail of a grid which is used in at least one embodiment of the inventive method.

FIG. 3 shows a contour generated with the aid of in at least one embodiment of the inventive method in an image recorded of a lung.

FIG. 4 shows a contour generated by way of at least one embodiment of the inventive method in an image recorded of an abdominal region.

FIG. 5 shows a contour resulting from a first set value in an image.

FIG. 6 a contour resulting from a second set value in the image shown in FIG. 5.

In the Figures, identical parts or areas, or parts or areas corresponding to one another, are labeled with the same reference numerals.

### DETAILED DESCRIPTION OF THE EXAMPLE EMBODIMENTS

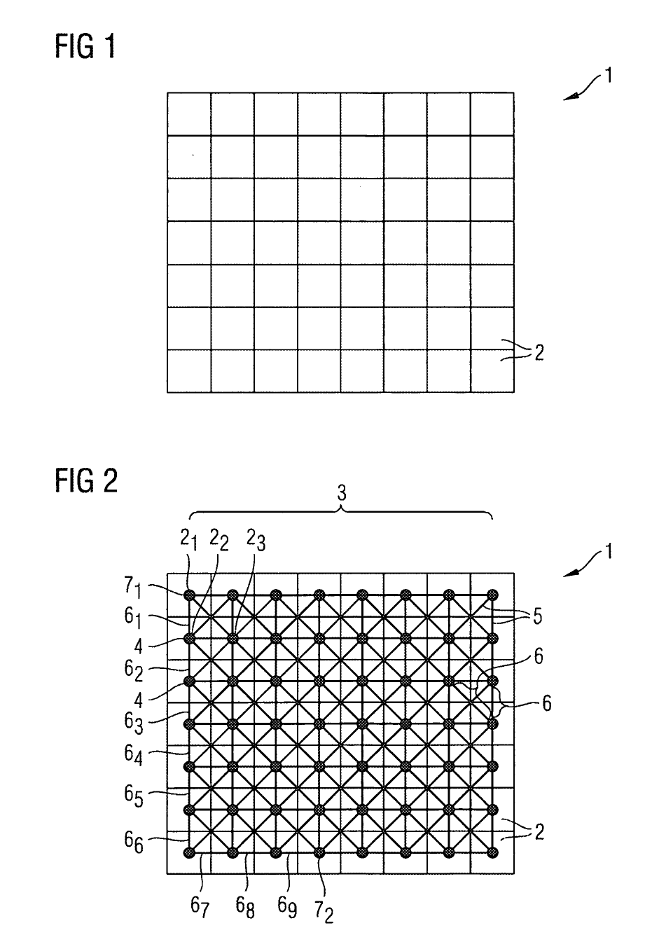

FIG. 1 shows a detail of a pixel array 1 which contains multiple pixels 2. A certain pixel value which represents a color hue or gray level is assigned to each pixel 2.

According to at least one embodiment of the invention, the pixel array 1 is mapped onto a grid 3, an example of such a grid being shown in FIG. 2. The grid 3 has multiple grid nodes 4 and grid lines 5, the grid lines 5 connecting the grid nodes 4 to one another. The grid nodes 4 represent the pixels 2 of the pixel array 1. A grid-line section value is assigned to each grid-line section 6, which represents the section of the corresponding grid lines 5 between two grid nodes 4. The user then defines two of the grid nodes 4 as contour reference points 7.

In this example, the grid nodes 4 labeled with the reference numeral 7₁ and with the reference numeral 7₂ are selected as contour reference points. The respective sums of the grid-line section values are then formed for multiple grid-line paths between the contour reference points 7₁ and 7₂. For example, the grid-line section values for the grid-line sections labeled with reference numerals 6₁ to 6₉ are added, the resulting sum corresponding to one of the possible grid-line paths between the contour reference points 7₁, 7₂. The particular grid-line path, the sum of whose associated grid-line section values assumes a minimum, represents the course of the contour to be determined between the contour reference points 7₁, 7₂.

The grid-line section values are derived from the pixel values of those pixels 2 which are connected to one another by the corresponding grid-line path and/or from the pixel values of pixels 2 adjacent thereto and/or from the geometric lengths of the grid-line sections 6. Thus, for example, the absolute value of the gradient which is defined by the pixel values associated with the pixels 2₁, 2₂ can be assigned to the grid-line section 6₁. Alternatively, for example, the negative absolute value of the gradient which is defined by the pixel values associated with the pixels 2₂, 2₃ can be assigned to the grid-line section 6₁.

In an example embodiment, these assignment methods are combined with one another. Here, a control parameter determines the weighting of the different methods relative to one another. Thus, for example, a high control parameter value can imply that only the geometric lengths of the grid-line sections 6 are input into the calculation of the grid-line section values, and a low set value can imply that only gradients between pixel values are input into the calculation of the grid-line section values. A moderate set value can then signify a mix of these three calculation methods.

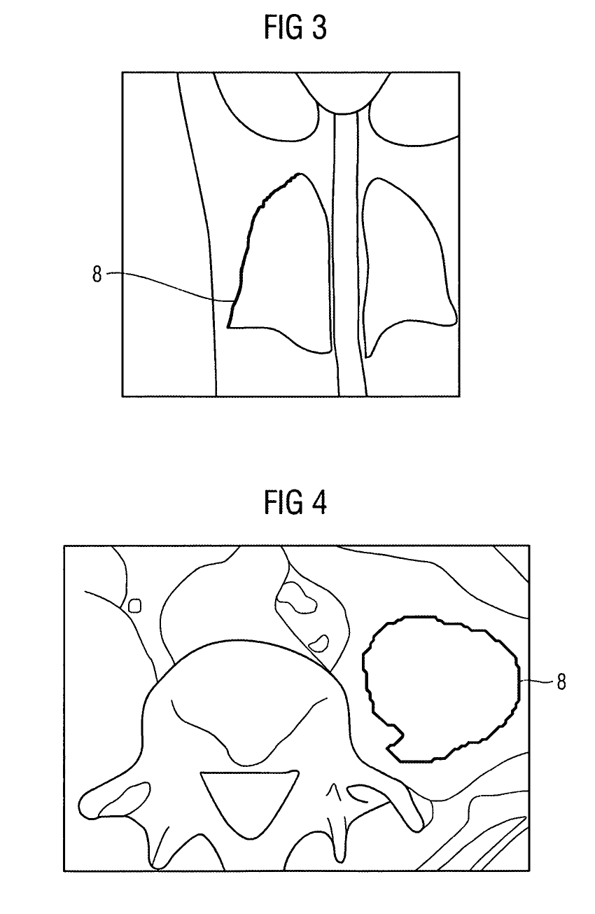

FIGS. 3 and 4 show contours 8 calculated by way of the method according to at least one embodiment of the invention.

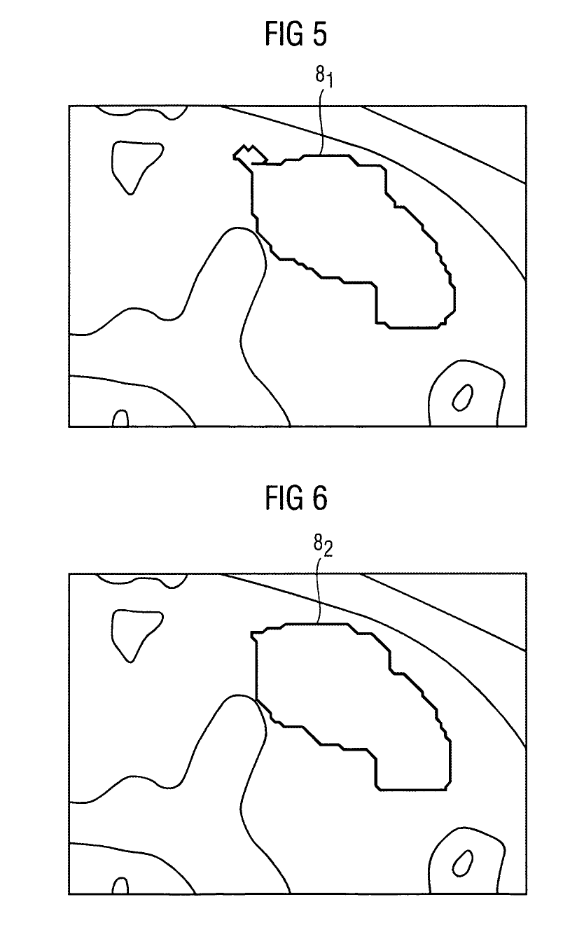

In FIGS. 5 and 6, an embodiment of the inventive method is applied in each case to the same image, the contour 8₁ calculated in FIG. 5 being based on a different control parameter value from the contour 8₂ determined in FIG. 6. The calculation which produces the contour 8₁ shown in FIG. 5 includes a greater proportion relating to the calculation of grid-line section values resulting from pixel-value gradients than the calculation which produces the contour 8₂ shown in FIG. 6 (in this calculation, the “emphasis” is more on the geometric lengths of the grid-line sections 6).

The description below is intended to explain further aspects of embodiments of the invention:

Embodiments of the invention relates to the use of multi-criteria shortest-path algorithms for contour identification/image segmentation in medical recordings.

The identification of contours in medical recordings (X-ray, CT, etc.) requires a high degree of medical know-how and, where carried out manually, a high outlay in terms of time and therefore also of cost. The identification of such contours (of organs, tumors, etc.) is necessary for diagnostic purposes, but above all also for treatment planning (radiation).

On account of the background medical knowledge required, there can be no question of fully automatic methods, nor would these meet with acceptance. Instead, a method is sought in at least one embodiment, which in conformance with expectations quickly calculates a contour, once a few reference points have been input. Such a method is described below and is the subject matter of at least one embodiment of the invention.

A principle underlying at least one embodiment of the invention is to map the problem of contour calculation on to a “shortest-path problem” on a graph. The pixels of the image are interpreted in this case as nodes of a graph. Edges of the graph preferably connect horizontally, vertically or diagonally adjacent pixels; the out degree of nodes is thus restricted to eight.

The edges of the graph are assigned cost values (“grid-line section value”). Cost components can be e.g.:
1. The negative absolute value of the gradient of the pixel gray levels perpendicular to the contour to be calculated.
2. The absolute value of the gradient of the pixel gray levels in the direction of the contour to be calculated.
3. The geometric length of an edge.

The first cost component leads to the path hugging the contour: if the gray levels are imagined as height data, then the calculated path runs along a slope edge. The second component serves to keep the path at as constant a level as possible, and the third component prevents meandering of the path in order to “take in” as many cross-gradient shares of the cost as possible.

The calculation of the contour proceeds from reference points specified (preferably by the user). Every two consecutive reference points serve as start and target nodes for calculating a shortest (i.e. cost-minimizing) path. In order to calculate a path, the above-mentioned cost components can, in the simplest case, be combined into a weighted sum. Embodiments of the invention are not, however, restricted hereto. In order to calculate the path, the well-known Dijkstra algorithm can then be used:

Priority queue q;

for all nodes v: distance (v) = ∞;
distance(start) = 0;
q.insert(start);
while ((v = q.del_min( ))) { || while q not empty

if (v == target) break;
for direction d = 1 .. 8:

find node w in direction d from v
calculate cost (v,w) in direction d
if (distance (w) > distance(v) + cost(v, w))

| if (distance(w) == ∞) q.insert(w); | |
|---|---|
| else | q.update(w); |

back(w) = v;

}

}

}

trace path form v to start using back-values;

The result of this calculation depends on the weightings with which the above-mentioned cost components are combined into a cost value. In an efficient implementation of the shortest-path algorithm, the user can (e.g. on a slider) change the cost mix and observe directly how the calculated path changes and thus select the most suitable contour for his/her diagnostic or therapeutic purposes.

As an alternative to the weighted combination of shares of the cost, the path costs can also be optimized according to multiple criteria.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. Method for determining a grid-line path for determining at least one contour in at least one image represented by a pixel array, a certain pixel value representing a color hue or gray level being assigned to each pixel of the pixel array, the method comprising:
stipulating at least two contour reference points, each contour reference point corresponding to a pixel of the pixel array;
mapping the pixel array onto a grid, grid nodes representing the pixels of the pixel array and grid lines connecting the grid nodes to one another;
assigning a certain grid-line section value to each grid-line section between two grid nodes;
determining a respective sum of all the grid-line section values for multiple grid-line paths between the contour reference points; and
determining the grid-line path, the sum of whose associated grid-line section values assumes a minimum, the grid-line path determined representing the at least one contour to be determined.

2. Method according to claim 1, wherein the grid-line section values are derived from at least one of the pixel values of the particular pixels connected to one another by the corresponding grid-line path, from the pixel values of pixels adjacent thereto and from the geometric lengths of the grid-line sections.

3. Method according to claim 2, wherein the negative absolute values of the gradients of the pixel values perpendicular to the corresponding grid-line path are input into the calculation of the grid-line section values.

4. Method according to claim 2, wherein the absolute values of the gradients of the pixel values along the corresponding grid-line path are input into the calculation of the grid-line section values.

5. Method according to claim 1, wherein multiple calculation methods are input into the calculation of the grid-line section values, wherein the different calculation methods are weighted relative to one another in accordance with a control parameter.

6. Method according to claim 1, wherein each grid node is connected via grid-line sections running horizontally, vertically and diagonally to the eight nearest grid nodes.

7. Method according to claim 1, wherein the control parameter is at least one of specifiable and modifiable by a user.

8. Method according to claim 1, wherein the contour reference points are at least one of specifiable and modifiable by a user.

9. Method according to claim 1, wherein the determining of the grid-line path which represents the contour to be determined is effected using the Dijkstra algorithm.

10. Method according to claim 3, wherein the absolute values of the gradients of the pixel values along the corresponding grid-line path are input into the calculation of the grid-line section values.

11. Method according to claim 2, wherein multiple calculation methods are input into the calculation of the grid-line section values, wherein the different calculation methods are weighted relative to one another in accordance with a control parameter.

12. Method according to claim 2, wherein each grid node is connected via grid-line sections running horizontally, vertically and diagonally to the eight nearest grid nodes.

13. Method according to claim 2, wherein the control parameter is at least one of specifiable and modifiable by a user.

14. Method according to claim 2, wherein the contour reference points are at least one of specifiable and modifiable by a user.

15. Method according to claim 2, wherein the determining of the grid-line path which represents the contour to be determined is effected using the Dijkstra algorithm.

16. A computer readable medium including program segments for, when executed on a computer, causing the computer to implement the method of claim 1.

17. A method, comprising:
stipulating at least two contour reference points, each contour reference point corresponding to a pixel of a pixel array;
mapping the pixel array onto a grid, grid nodes representing the pixels of the pixel array and grid lines connecting the grid nodes to one another;
assigning a certain grid-line section value to each grid-line section between two grid nodes;
determining a respective sum of all the grid-line section values for multiple grid-line paths between the contour reference points; and
determining the grid-line path, the sum of whose associated grid-line section values assumes a minimum;
determining contours from the determined grid-line path in at least one image represented by the pixel array, a certain pixel value representing a color hue or gray level being assigned to each pixel of the pixel array.

18. A computer readable medium including program segments for, when executed on a computer, causing the computer to implement the method of claim 17.
